(19) United States
(12) Patent Application Publication
(10) Pub. No.: US 2014/0109551 A1
(43) Pub. Date: Apr. 24, 2014

(54) SOLID CHEMICAL ROCKET PROPULSION SYSTEM

(71) Applicants: Los Alamos National Security, LLC, (US); Grant A. Risha, (US)

(72) Inventors: Bryce C. Tappan, Santa Fe, NM (US); Grant A. Risha, Port Matilda, PA (US)

(73) Assignee: Los Alamos National Security, LLC, Los Alamos, NM (US)

(21) Appl. No.: 13/828,371

(22) Filed: Mar. 14, 2013

Related U.S. Application Data
(60) Provisional application No. 61/717,400, filed on Oct. 23, 2012.

(51) Int. Cl. F02K 9/08

(52) U.S. Cl. CPC F02K 9/08
USPC 60/253

(57) ABSTRACT

A solid chemical rocket propulsion system includes a solid fuel and a solid oxidizer that is physically separated from the solid fuel and is not mixed with solid fuel while the rocket is initially at rest.

### RELATED APPLICATIONS

This application claims the benefit of U.S. Provisional Application 61/717,400 filed entitled “Solid Chemical Rocket Propulsion System,” which was filed Oct. 23, 2012, incorporated by reference herein.

### STATEMENT REGARDING FEDERAL RIGHTS

This invention was made with government support under Contract No. DE-AC52-06NA25396 awarded by the U.S. Department of Energy. The government has certain rights in the invention.

### FIELD OF THE INVENTION

The present invention relates generally to rocket propulsion systems and more particularly to a solid rocket propulsion system having a solid fuel and a solid oxidizer ndovalwherein the solid fuel is physically separated from the solid oxidizer and is not mixed with the solid oxidizer when the rocket is initially at rest.

### BACKGROUND OF THE INVENTION

Solid chemical rocket propulsion relates to propulsion of a rocket using energy released by chemical combustion of stored solid propellant. The propulsion aspect of chemical rocket propulsion relates to changing the motion of the rocket when it is initially at rest, or changing its velocity in order to overcome forces on the rocket while the rocket moves through a chosen environment. A propellant for a rocket propulsion system is a chemical composition that provides stored chemical energy for propulsion of the rocket. The propellant includes a solid fuel and a solid oxidizer. The solid fuel and solid oxidizer are typically in the form of a mixture held together with a binder. Ignition of the mixture results in a chemical reaction. When the fuel reacts with the oxidizer, the resultant chemical reaction is chemical combustion. Chemical combustion releases the stored energy of the propellant.

Jet propulsion refers to movement of an object due to forces from matter ejected from the object. Chemical rocket propulsion is a subset of jet propulsion in which matter ejected from the nozzle of the rocket is stored onboard the rocket. The ejected matter includes chemical combustion products, and also propellant that has not completely combusted. Combustion reactions result in the formation of gaseous combustion products having thermal energy. The thermal energy is converted to kinetic energy when these gaseous combustion products expand through the nozzle of the rocket. FIG. 1 shows a schematic diagram of a rocket 10 with a typical solid chemical propulsion system. Rocket 10 includes payload 12 and chamber 14 for storing solid propellant 16. The solid propellant 16 shown is a mixture of ammonium perchlorate (“AP”) and hydroxyl-terminated polybutadiene (“HTPB”). Reaction of the AP with the HTPB is a combustion reaction releasing the stored energy of the propellant. Ignition of the propellant in these types of rockets is typically done using a hot wire ignition system. The reaction of the oxidizer AP with the fuel HTPB generates gaseous combustion reaction products that are expelled from nozzle 17 to provide thrust for rocket 10.

The performance of the rocket depends on the choice of fuel and oxidizer. If the fuel and oxidizer are combined in their solid form to produce the combustion reaction, the rocket is called a solid propellant rocket. Solid propellant rockets have solid rocket propulsion systems that include a solid fuel and a solid oxidizer.

While solid rocket propulsion systems are reliable systems, they have long since reached their limit in terms of their achievable safety and performance. Nevertheless, the US Department of Defense (USDOD), NASA, and commercial organizations continue to request increasingly higher energy systems with an increased level of safety. These two characteristics (i.e. higher energy and safety), however, are almost always mutually exclusive. The highest energy systems are almost always the most hazardous.

Another type of rocket propulsion system is a hybrid propulsion system that combines an inert solid fuel contained within a combustion chamber in the rocket with a separately stored liquid, gaseous, or gel oxidizer. FIG. 2 shows a schematic diagram for a typical hybrid propulsion system. FIG. 2 shows rocket 18 having a payload 20 and chamber 22 for liquid oxidizer 24. Rocket 18 also includes chamber 26 for solid fuel 28. A valve 30 is provided for oxidizer to flow from chamber 22 into chamber 26 so that the liquid oxidizer 24 can mix with, and then react with, the fuel 28. In this case, which is typical of hybrid propulsion systems, the oxidizer is a liquid, the fuel is a solid, and the oxidizer and fuel are separated. The oxidizer is fluid, and flows through a valve 29 to the fuel. The rocket also includes a mixing chamber 30 where the fuel and oxidizer mix and react to form gaseous combustion reaction products that are expelled from the rocket through nozzle 32. Hybrid systems are attractive due their simple design, high level of operational safety, on/off throttle tailoring capability, storage lift, and production costs. Despite various safety and operational advantages of hybrid propulsion systems, they suffer from low solid fuel grain surface regression rates requiring a relatively large fuel surface for attaining a given level of thrust. Hybrid systems also have a tendency for an incomplete combustion reaction before the products exit the chamber.

### SUMMARY OF THE INVENTION

The present invention provides a rocket propulsion system comprising of a solid energetic fuel and a solid oxidizer. The solid energetic fuel is physically separated from the solid oxidizer and is not mixed with the solid oxidizer while the rocket is initially at rest.

### BRIEF DESCRIPTION OF THE DRAWINGS

The accompanying drawings, which are incorporated in and form a part of the specification, illustrate the embodiments of the present invention and, together with the description, serve to explain the principles of the invention. In the drawings:

FIG. 1 shows a schematic diagram for a rocket having a typical solid rocket propulsion system.

FIG. 2 shows a schematic diagram for a rocket having a typical hybrid rocket propulsion system.

FIG. 3 shows a schematic diagram for a rocket having an embodiment solid rocket propulsion system.

FIG. 4 shows a small scale motor for testing an embodiment rocket propulsion system.

FIG. 5 shows a graph of calculated chamber pressure versus time for the small scale motor of FIG. 4.

FIG. 6 shows a graph of burning rate versus pressure for composite mixtures of binders with triaminoguanidinium azotetrazolate (TAGzT).

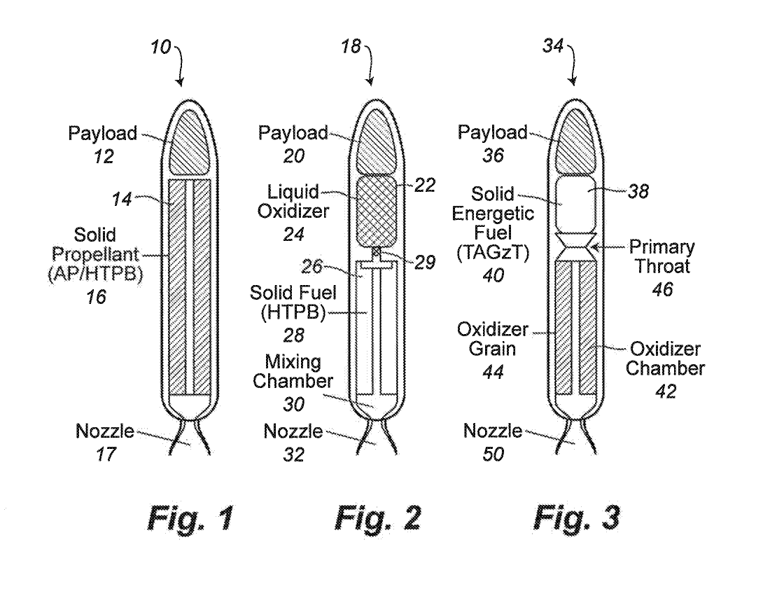

### DETAILED DESCRIPTION

This invention relates to a solid chemical rocket propulsion system in which the solid fuel and solid oxidizer are not mixed with one another and are physically separated from one another while the rocket is initially at rest. An embodiment rocket with an embodiment solid chemical rocket propulsion system is shown in FIG. 3. Rocket 34 includes payload 36, a fuel chamber 38 for solid fuel 40, an oxidizer chamber 42 for solid oxidizer 44, and a primary throat 46 which is located in-between fuel chamber 38 and oxidizer chamber 42, and provides communication between fuel chamber 38 and oxidizer chamber 42. Embodiment rocket 34 also includes a mixing chamber 48 and nozzle 50. Mixing chamber 48 is located in between oxidizer chamber 42 and nozzle 50.

The rocket propulsion system for rocket 34, which at a minimum includes a combination of solid fuel 40 and solid oxidizer 44, is expected to provide rocket 34 with a high level of safety that will allow the utilization of higher energy solid fuels and solid oxidizers, and is expected to be a higher performing system than current solid rocket propellant systems. Solid rocket propulsion systems of this invention will be safer than known solid rocket propulsion systems because the solid fuel and solid oxidizer of embodiment systems are not mixed together when the rocket is initially at rest. The solid fuel and solid oxidizer of embodiment solid rocket propulsion systems are physically separated from one another and not mixed with each other. Even through the solid fuel and solid oxidizer used in embodiment systems are high energy ingredients, the rocket propulsion systems are safer than known solid rocket propulsion systems because the solid fuel and solid oxidizer are kept apart from one another until the rocket is launched.

Embodiment rocket propulsion systems of this invention include solid fuels that are chemical compounds that are high nitrogen-containing, high hydrogen-containing chemical compounds. Such high nitrogen-containing, high hydrogen-containing chemical compounds contain a minimal amount of oxygen, or no oxygen. In an embodiment, a solid fuel includes the known high-nitrogen, high hydrogen-containing chemical compound dihydrazinotetrazine. In another embodiment, a solid fuel includes the known high nitrogen-containing, high hydrogen-containing compound triaminoguanidinium 5,5′-dinitro-3,3′azo-1,2,4-triazole. In another embodiment, a solid fuel includes the known high nitrogen-containing, high hydrogen-containing compound triaminoguanidinium azotetrazolate, which has the chemical structure below.

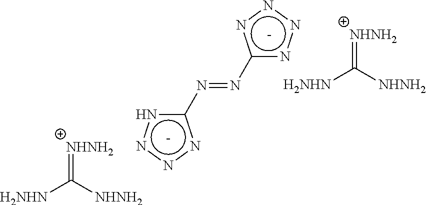

Triaminoguanidinium azotetrazolate is a bright yellow, needle-like crystalline solid having a theoretical maximum density of 1.60 g/cm³, a decomposition temperature of 195 degrees Celsius, and a heat of formation of +257 kcal/mol. The azotetrazolate anion is also capable to being associated with other cations that also impart high fuel content and can be used in this application. Suitable cations include hydrazinium, ammonium, guanidinium, monoaminoguanidinium, diaminoguanidinium, and ethylenediammonium. Likewise, energetic anions can be associated with the aforementioned cations wherein such energetic anions include tetrazolate, aminotetrazolate, 3-amino-5-nitro-1,2,4-triazole, 5,5′-dinitro-3,3′azo-1,2,4-triazole and 3,6-bis-nitroguanyl-1,2,4,5-tetrazine.

An embodiment rocket propulsion system, such as for rocket 34 shown in FIG. 3, may include triaminoguanidinium azotetrazolate as solid fuel 40. Such a system is a tandem system that is designed such that the high nitrogen/high hydrogen materials energetically decompose to provide gaseous products that include hydrogen (H₂) and other fuel products, which react with solid oxidizer 44 and with various oxidizing species that are formed from the solid oxidizer 44 to form combustion products that exit nozzle 46. As FIG. 3 shows, the high nitrogen-containing, high hydrogen-containing solid fuel located in solid fuel chamber 38 is physically separated from the solid oxidizer, and does not mix with the oxidizer while the rocket is at rest. Thus, both the solid oxidizer 44 such as ammonium perchlorate, and the solid fuel 40 such as triaminoguanidinium azotetrazolate, are relatively insensitive to shock while each remains separated from one another before the rocket is launched, which greatly reduces the chances of an accidental detonation or initiation of the rocket.

Solid fuel 40 may be in the form of solid particles pressed together with or without a binder. Triaminoguanidinium azotetrazolate, for example, may be pressed neat (i.e. without a binder), or with a binder such as estane.

Solid fuel 40 may be cast-cured with binder systems such as hydroxyl-terminated polybutadiene (HTPB) and/or glycidyl azide polymer (“GAP”). These fuels may then be placed into chamber 38 with a nozzle design such that the pressure will be higher than in the oxidizer chamber. The oxidizer chamber contains the solid oxidizer, which may be pressed ammonium perchlorate, pressed ammonium nitrate (AN) or combinations of AP and AN, or combinations of various solid oxidizers that include, but are not limited to, AN, AP, ammonium dinitramide, hydrazinium nitroformate, hydroxylammonium nitrate, and hydroxylammonium perchlorate. The oxidizer may be blended with one or more binders before pressing to improve mechanical properties and modify burning rates. For example, a formulation containing 5% VITON A will be expected to reduce the reaction rate while also imparting mechanical strength to the oxidizer grain. Depending on the geometry of the motors, the burning rate of the energetic fuel can be modified by the formulation, or by altering the chamber pressure. Once combusted, the gaseous fuel (i.e. the H₂ released from the solid high nitrogen-containing, high hydrogen-containing solid fuel) exits the fuel chamber 38 and enters the center-perforated oxidizer grain mounted in the oxidizer chamber 42. The oxidizer grain 44 may have various geometries of perforation to allow the hot gaseous fuel to transit and ablate and/or react on the surface of the oxidizer grain or in the aft mixing chamber 48, thus producing different levels of thrust or varying stoichiometry.

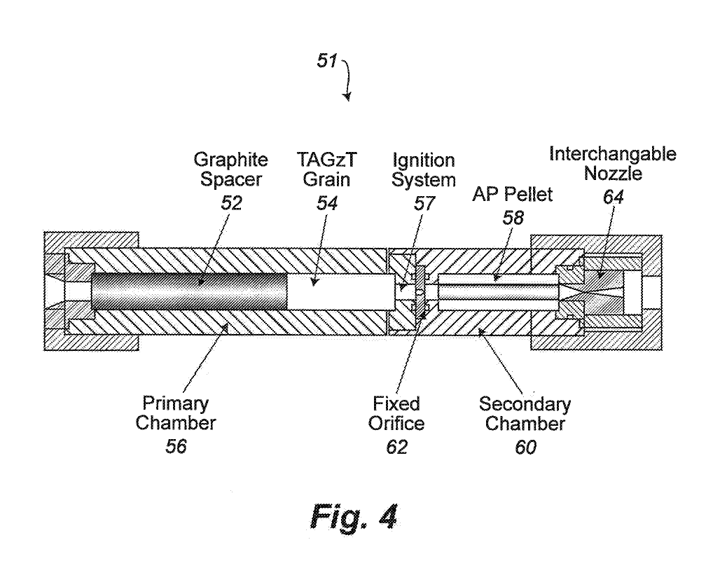

FIG. 4 shows an embodiment small scale test motor that was designed and built to allow rapid screening of fuels and oxidizers. Test motor 51 resembles an embodiment solid rocket propulsion system, as both include the solid fuel chamber, solid fuel, oxidizer chamber, oxidizer, and nozzle through which gaseous combustion products exit and provide thrust. Test motor 51 includes graphite spacer 52 adjacent solid fuel 54, which in the embodiment shown is a grain of the solid fuel triaminoguanidinium azotetrazolate (“TAGzT”) in solid fuel chamber 56, and ignition system 57 for igniting the solid fuel. Test motor 50 also includes solid oxidizer 58 in solid oxidizer chamber 60. Graphitic spacer 52 allows for flexibility in changing the length of the portion of solid fuel 54 inside solid fuel chamber 56. A fixed orifice 62 provides communication between solid fuel chamber 56 and solid oxidizer chamber 60 so that gases, which include hydrogen (H₂) and nitrogen (N₂) which form from high nitrogen-containing, high hydrogen-containing solid fuel grain TAGzT, can enter solid oxidizer chamber 60 and mix with solid oxidizer 58. Test motor 51 also includes a nozzle 64 as an exit for gaseous combustion products.

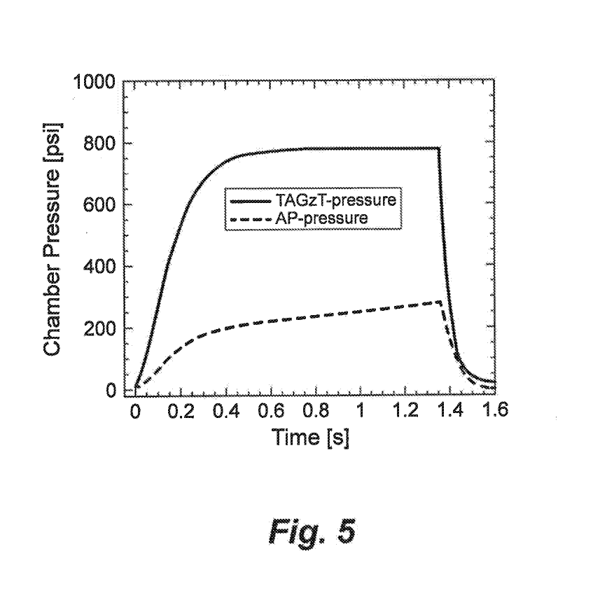

FIG. 5 shows a graph of calculated chamber pressure versus time for the small scale motor 51 of FIG. 4.

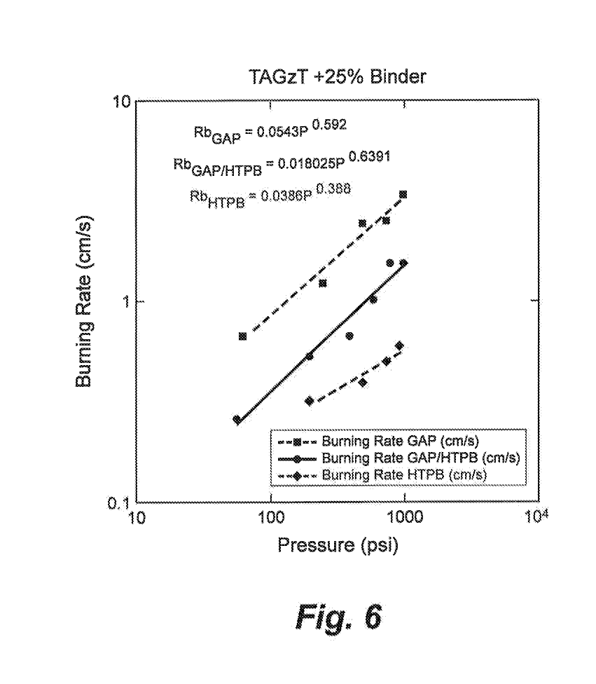

The solid fuel from inside motor 51 was ignited with a hot wire and a small amount of ignition material made from ammonium perchlorate and hydroxyl-terminated polybutadiene (HTPB) and aluminum. FIG. 6 shows a graph of burning rate versus pressure for composite mixtures of TAGzT with binders. A variety of fuels were tested. Pure TAGzT was tested, as was TAGzT with 5% estane binder. A fuel composed of 75% TAGzT with 22.5% HTPB and 2.5% methylene diphenyl diisocyanate (MDI), was tested. A fuel composed of 75% TAGzT, 11.25% HTPB and 11.25% GAP and 2.5% MDI was tested. A fuel composed of 75% TAGzT, 22.5% GAP and 2.5% MDI was tested. Data from each test was plotted as burning rate versus pressure.

The fuel decomposed to produce hot fuel gases that exited the fuel chamber 56 and entered chamber 60 through orifice 62. As a result of the elevated temperatures and pressures of the hot fuel gases, the oxidizer decomposed and released oxidizer gas. The gases from the fuel and oxidizer reacted. This was the primary energy release from the stored chemical energy of motor 51. Finally, the hot gases exited the nozzle 64, creating thrust.

In an embodiment, the solid high nitrogen-containing, high hydrogen-containing fuel may also include aluminum in the form of micron or nano-sized particles. The aluminum nanoparticles are expected to modify burning rates without a loss in safety. The nanoparticles of aluminum would be mixed with the fuel but not with the oxidizer when the rocket is initially at rest. Addition of such metal nanoparticles is expected to decrease the sensitivity when added to an energetic fuel such as a high nitrogen-containing, high hydrogen containing compound.

Known solid rocket propulsion systems typically employ elemental aluminum as fuel and ammonium perchlorate as the oxidizer. Because of the safety gain of embodiment systems, these standard ingredients of known systems may be replaced by more energetic and more environmentally friendly ammonium dinitramide and aluminum hydride, which if physically mixed, form extremely sensitive explosives.

Although the present invention has been described with reference to specific details, it is not intended that such details should be regarded as limitations upon the scope of the invention, except as and to the extent that they are included in the accompanying claims.

1. A rocket propulsion system comprising:
a solid energetic fuel, and
a solid oxidizer,
wherein said solid energetic fuel is physically separated from the solid oxidizer and is not mixed with the solid oxidizer while the rocket is initially at rest.

2. The rocket propulsion system recited in claim 1, further comprising:
a first chamber for storing said solid fuel, and
a second chamber for storing said solid oxidizer,
wherein said first chamber is in communication with said second chamber.

3. The rocket propulsion system recited in claim 1 wherein said solid fuel is a energetic high nitrogen-containing, high hydrogen-containing compound capable of self-decomposition and contains little or no oxygen.

4. The rocket propulsion system recited in claim 3, wherein said energetic high nitrogen-containing, high hydrogen-containing compound includes at least one cation comprising hydrazinium, ammonium, guanidinium, monoaminoguanidinium, diaminoguanidinium, triaminoguanidinium, or ethylene diammonium.

5. The rocket propulsion system recited in claim 4, wherein said energetic high nitrogen-containing, high hydrogen-containing compound includes at least one anion comprising tetrazolate, aminotetrazolate, 3-amino-5-nitro-1,2,4-triazole, 5,5′-dinitro-3,3′azo-1,2,4-triazole, or 3,6-bis-nitroguanyl-1,2,4,5-tetrazine.

6. The rocket propulsion system recited in claim 1, wherein said solid oxidizer includes at least one compound comprising ammonium perchlorate, ammonium nitrate, ammonium dinitramide, hydrazinium nitroformate, hydroxylammonium nitrate, or hydroxylammonium perchlorate.

7. The rocket propulsion system recited in claim 3, wherein said high nitrogen-containing, high hydrogen-containing compound comprises at least one of triaminoguanidinium azotetrazolate, dihydrazinotetrazine, and triaminoguanidinium dinitroazotriazine.

8. The rocket propulsion system recited in claim 7, wherein said solid oxidizer comprises at least one of ammonium perchlorate and ammonium nitrate.
